(19) United States
(12) Patent Application Publication
(10) Pub. No.: US 2018/0063239 A1
(43) Pub. Date: Mar. 1, 2018

(54) METHOD AND SYSTEM FOR BIDIRECTIONAL INSTANT LIVING RESOURCE MUTUAL ASSISTANCE AND EMOTION EXCHANGE INTERACTION

(71) Applicant: Boris Wu, Longyan (CN)

(72) Inventor: Boris Wu, Longyan (CN)

(21) Appl. No.: 15/561,072

(22) PCT Filed: Mar. 26, 2015
(86) PCT No.: PCT/CN2015/075129

§ 371 Date: Sep. 25, 2017

(51) Int. Cl. H04L 29/08

(52) U.S. Cl. CPC H04L 67/1061; G06F 3/0482; H04L 67/26; H04L 67/18

(57) ABSTRACT

Disclosed are a method and a system for bidirectional instant living resource mutual assistance and emotion exchange interaction. The method includes the steps of establishing a digital and quantitative P2P network platform, publishing supply and demand information, performing accurate matching, performing synchronous pushing, performing mutual-trust bidirectional selection, and performing further exchange on a mutual-communication interface. Both sides are enabled to have the right of acquiring information about an opposite side through the synchronous pushing, and the purposes of mutual trust, mutual assistance, mutual communication and emotion exchange interaction are achieved through the bidirectional selection.

### BACKGROUND OF THE INVENTION

### 1. Field of the Invention

The present invention relates to a method for bidirectional instant living resource mutual assistance and emotion exchange interaction and a system thereof.

### 2. Description of the Prior Art

P2P is the abbreviation of peer-to-peer. Peer means colleagues and partners and the like. In this way, P2P can be understood as “partner to partner”, or called peer-to-peer networking.

Simply, P2P is directly to associate with people, so that people directly interact through the Internet. P2P makes the communication on the network easier to achieve direct sharing and interaction. Through P2P, a person can directly connect with the terminals of other users, rather than connecting with the server to browse and download. Another feature of P2P is to change the big site as the center of the Internet to “non-central” and to return the power to the user. P2P seems to be very innovative like B2C, B2B. The common things in the real word are placed on the Internet. In real life, people communicate with each other face to face or by telephone in accordance with P2P mode. In the final analysis, all the social relations are the relationship between people. Therefore, the inventor establishes a framework to shorten the distance between people based on P2P platform, so that people can communicate with each other anywhere for mutual trust, mutual assistance and mutual communication. Through the platform, nearby suppliers and demanders can be instantly associated together for mutual trust, mutual assistance and mutual communication between people. Life is more convenient.

There are many platforms, such as shopping platforms, dating and other platforms, which give suppliers the way to advertise their own services. However, the publishing of the ad has a significant shortcoming, that is, both parties cannot contact each other immediately. The communication between both parties is difficult to do immediately, and it often needs a long time to wait for each other to reach the intention of both parties.

Accordingly, the inventor of the present invention has devoted himself based on his many years of practical experiences to solve these problems.

### SUMMARY OF THE INVENTION

The primary object of the present invention is to provide a method for bidirectional instant living resource mutual assistance and emotion exchange interaction and a system thereof, with the aim of enabling nearby suppliers and demanders to be instantly associated together for mutual trust, mutual assistance and mutual communication between people. Interpersonal emotion exchange interaction can be carried out immediately. The method is much more user-friendly and more convenient.

According to one aspect of the present invention, a method for bidirectional instant living resource mutual assistance and emotion exchange interaction is provided. The method comprises the steps of:

step 1, establishing a digital and quantitative P2P network platform, categories of demand and supply being established on the digital and quantitative P2P network platform, the categories including a living resource mutual assistance category and an emotion exchange interaction category, the P2P network platform being only set with touch click options for a demander and a supplier, not self-defining;

step 2, publishing supply and demand information, the supplier touching and selecting a service category provided on a supply publishing interface of the P2P network platform and publishing the supply information on the P2P network platform, a cloud of the P2P network platform immediately searching for the corresponding demand information being published by the demander corresponding to the supply information, wherein when the supplier exits the P2P network platform, the P2P network platform immediately stops publishing the supply information and the cloud stops searching;

the demander touching and selecting a demand category provided on a demand publishing interface of the P2P network platform and publishing the demand information on the P2P network platform, the cloud of the P2P network platform immediately searching for the supply information being published by the supplier and corresponding to the demand information, wherein when the demander exits the P2P network platform, the P2P network platform immediately stops publishing the demand information and the cloud stops searching;

step 3, performing accurate matching, the P2P network platform automatically matching all the supply information and the demand information of the cloud according to best matching conditions, a plurality of suppliers and demanders in the same area being selected by distance;

step 4, performing synchronous pushing, the plurality of selected suppliers according to the distance close to the demander being listed and displayed on the demand publishing interface, meanwhile, the plurality of selected demanders according to the distance close to the supplier being listed and displayed on the supply publishing interface;

step 5, performing mutual-trust bidirectional selection, the supplier and demander communicating with each other according to the synchronously displayed supply and demand information, wherein when the supplier and the demander choose each other, the publishing interfaces of the supplier and the demander synchronously pop a mutual-communication interface. Preferably, when both the supplier and demander select the living resource mutual assistance category, the method further comprises the steps of:

step 6, performing task confirmation, the mutual-communication interface being set with a continuing task option and a quitting task option, wherein when both the supplier and the demander touch the continuing task option to be in an executing task state, the supplier and the demander are unable to perform task publishing, on the contrary, when the supplier or the demander touches the quitting task option, the task immediately terminates and exits the mutual-communication interface, going back to step 2;

step 7, terminating task, the P2P network platform of the demander being set with a task completion option, wherein when the demander touches the task completion option, the task terminates, and the supplier and the demander can continue to publish tasks.

Preferably, in step 1, each of the categories has sub-categories, each of the categories forms a main module, and each of the sub-categories forms a sub-module.

Preferably, in step 2, when in the same category, only one identity, the supplier or the demander, is selected to perform task publishing; when in different categories, both identities, the supplier and the demander, can be selected to perform task publishing.

Preferably, the method further comprises the step of performing identity information authentication for the supplier and the demander before step 2. Through the identity authentication, the supplier and the demander are allowed to perform task publishing. The P2P network platform tracks and records identity the information, location information and task information of the supplier and the demander in step 2 to step 7. The categories include a relative category. The supplier or the demander is added as a relative in a sub-category of the relative category.

According to one another aspect of the present invention, a system for bidirectional instant living resource mutual assistance and emotion exchange interaction is provided. The system comprises:

a digital and quantitative P2P network platform module, the digital and quantitative P2P network platform module being installed in a smart terminal for a supplier and a demander, the digital and quantitative P2P network platform module being preset with categories of demand and supply, the categories including a living resource mutual assistance category and an emotion exchange interaction category, the P2P network platform module being set with touch click options for the demander and supplier, not including self-defining options;

a supply and demand information publishing module, a cloud searching module, a locating module, an accurate matching module, a synchronous pushing module, a mutual-trust bidirectional selection module and an identity state monitoring module being set in the P2P network platform module;

the supply and demand information publishing module being provided with a supply publishing interface and a demand publishing interface; the supply publishing interface being used for the supplier to touch and select a service category provided by the supplier and to publish the supply information on the P2P network platform module;

the demand publishing interface being used for the demander to touch and select a service category required for the demander and to publish the demand information on the P2P network platform module;

the cloud searching module being connected with the supply and demand information publishing module and the locating module respectively, the cloud searching module being used to search for the supply information and the demand information that are being published;

the locating module being used to detect location information of the supplier and demander;

the accurate matching module being connected with the cloud searching module, the accurate matching module being used to automatically match all the supply information and the demand information of the cloud according to best matching conditions, and a plurality of suppliers and demanders in the same area being selected by distance;

the synchronous pushing module being connected with the accurate matching module, the synchronous pushing module being used for the plurality of selected suppliers according to the distance close to the demander to be listed and displayed on the demand publishing interface and for the plurality of selected demanders according to the distance close to the supplier to be listed and displayed on the supply publishing interface;

the mutual-trust bidirectional selection module being connected with the synchronous pushing module, the mutual-trust bidirectional selection module being used for the supplier and the demander to communicate with each other according to the listed and displayed information of the synchronous pushing module, the mutual-trust bidirectional selection module being provided with a mutual-communication interface, wherein when the supplier and the demander choose each other, the mutual-communication interface is popped;

the identity state monitoring module being connected with the supply and demand information publishing module and the cloud searching module respectively, the identity state monitoring module being used to detect the identity state of the supplier and the demander; wherein when the identity state monitoring module detects that the identity state of the supplier and the demander is in an offline state, the supply and demand information publishing module being prohibited from publishing the task of the supplier and the demander, meanwhile, the cloud searching module stops searching.

Preferably, the system further comprises a task confirmation module and a task termination module in the P2P network platform module.

The task confirmation module is disposed on the mutual-communication interface of the mutual-trust bidirectional selection module. When the supplier and the demander select the living resource mutual assistance category, the task confirmation module is displayed on the mutual-communication interface. The task confirmation module is provided with a continuing task option and a quitting task option. The task confirmation module is used to change the identity state of the supplier and the demander to an executing task state when both the supplier and the demander select the continuing task option. When the supplier or the demander touches the quitting task option, the task terminates immediately.

The task termination module is connected with the task confirmation module. The task termination module of the demander is provided with a task completion option. The task termination module is used for confirming the termination of the task when the demander touches the task completion option and for canceling the identity of the supplier and the demander in the executing task state.

The identity state monitoring module is connected with the task confirmation module. The identity state monitoring module is used to detect whether the supplier and the demander are still in the executing task state. When the identity state monitoring module detects that the identity state of the supplier and the demander is in the executing task state, the identity state monitoring module is used to prohibit the supply and demand information publishing module from publishing the task of the supplier and the demander, meanwhile, the cloud searching module stops searching.

Preferably, the P2P network platform module further includes main modules and sub-modules. The categories are pre-recorded in the main modules, respectively. The sub-categories of each category are pre-recorded in the sub-modules, respectively.

Preferably, the supply and demand information publishing module is used to ensure that when in the same category, only one identity, the supplier or the demander, is selected to perform task publishing; when in different categories, both identities, the supplier and the demander, can be selected to perform task publishing.

Preferably, the P2P network platform module is provided with a tracking and recording module and an identity information authentication module. The identity information authentication module is connected with the supply and demand information publishing module. The identity information authentication module is used for identity information authentication before the supplier and the demander perform task publishing. The tracking and recording module is connected with each of the aforesaid modules. The tracking and recording module is used for tracking and recording the identity information, location information and task information of the supplier and the demander. The categories preset and recorded in the digital and quantitative P2P network platform module include a relative category. The supplier or the demander is preset as a relative in a sub-category of the relative category.

The suppliers and the demanders of the present invention establish the digital and quantitative P2P network platform which only provides the mode of touch click selection, so that the subsequent accurate matching can be realized. The suppliers and demanders can be searched by the cloud only when the suppliers and demanders are publishing information, thereby ensuring the instantaneity of implementing tasks to ensure that both sides can provide timely response and waiting is not required. Nearby suppliers and demanders are associated together through the accurate matching and a principle of proximity and are not required to be sought artificially, thereby saving a large amount of time. Both sides are enabled to have the right of acquiring information about an opposite side through the synchronous pushing, and the purposes of mutual trust, mutual assistance, mutual communication and emotion exchange interaction are achieved through the bidirectional selection.

### BRIEF DESCRIPTION OF THE DRAWINGS

FIG. 1 is a block diagram according to an embodiment of the present invention.

### DETAILED DESCRIPTION OF THE PREFERRED EMBODIMENTS

Embodiments of the present invention will now be described, by way of example only, with reference to the accompanying drawings.

The present invention discloses a method for bidirectional instant living resource mutual assistance and emotion exchange interaction. The method comprises the following steps:

Step 1, establishing a digital and quantitative P2P network platform. Categories of demand and supply are established on the digital and quantitative P2P network platform. The P2P network platform is only set with touch click options for a demander and a supplier, not self-defining, thereby enabling the subsequent accurate matching to be implemented. Each of the categories has sub-categories. Each of the categories forms a main module. Each of the sub-categories forms a sub-module. The categories may include a living resource mutual assistance category, such as: taxi booking, room booking, home maintenance, and so on. The categories may include an emotion exchange interaction category, such as making friends according to interests, making friends according to emotion, and so on. As long as the digital quantitative supply and demand relationship can be provided, they can function as the categories of the present invention. The sub-categories are specific options. For example, in the taxing booking category, the sub-categories are the type of the car, the driver's gender, etc. In the interest category for making friends, the sub-categories may be concerns, interests, and so on.

Step 2, publishing supply and demand information. A supplier touches and selects a service category provided on a supply publishing interface of the P2P network platform and publishes the supply information on the P2P network platform. The cloud of the P2P network platform immediately searches for the demand information being published by a demander described below and corresponding to the supply information. Once the supplier exits the P2P network platform, the P2P network platform immediately stops publishing the supply information and the cloud stops searching.

The demander touches and selects a demand category provided on a demand publishing interface of the P2P network platform and publishes the demand information on the P2P network platform. The cloud of the P2P network platform immediately searches for the supply information being published by the supplier and corresponding to the demand information. Once the demander exits the P2P network platform, the P2P network platform immediately stops publishing the demand information and the cloud stops searching.

When in the same category, the user is allowed to select only one identity, the supplier or the demander. When in different categories, the user is allowed to simultaneously select two identities, the supplier and the demander. For example, the user may be a supplier to provide a taxi service and a demander to rent a room, who can simultaneously publish tasks until the implementation of one of the tasks.

The cloud only searches for the information that is being published, ensuring that the matching supplier or demander is online and that is real-time.

Step 3, performing accurate matching. The P2P network platform automatically matches all the supply information and demand information of the cloud according to the best matching conditions. Based on a positioning system, the supplier and the demander in the same area are selected by distance. There are many approaches to determine the position of the user, such as a GPS (global positioning system) which has been widely used.

Step 4, performing synchronous pushing. A plurality of selected suppliers according to the distance close to the demander are listed and displayed on the demand publishing interface, meanwhile a plurality of selected demanders according to the distance close to the supplier are listed and displayed on the supply publishing interface. Wherein, the number of the suppliers and demanders is preferably five, depending on the needs. Through the synchronization of both the supply and demand information pushed to the publishing interfaces of both sides, so that both sides can understand each other's information, rather than a unilateral understanding, thereby providing the necessary information for the subsequent mutual-trust selection.

Step 5, performing mutual-trust bidirectional selection, and performing further exchange on a mutual-communication interface. Both sides click and communicate with each other according to the synchronously displayed supply and demand information. When the supplier and the demander choose each other, the publishing interfaces of both sides synchronously pop a mutual-communication interface. The communication of the mutual-communication interface includes audio and video, text, etc. In the mutual-communication interface, both sides can conduct further exchanges. For the living resource mutual assistance category, both sides can discuss the specific needs and the specific details of the services through the mutual-communication interface to achieve the transaction. For the emotion exchange interaction category, both sides can perform emotion exchange interaction through the mutual-communication interface.

When the supply and demand relationship selected by both sides is the living resource mutual assistance category, in order to ensure the final service task is reached and in order to ensure the quality of the service, the following steps 6 and 7 are performed:

Step 6, performing task confirmation. The mutual-communication interface is set with a continuing task option and a quitting task option. When both sides touch the continuing task option to be in an executing task state, both sides are unable to perform task publishing. As long as both sides publish the task, it is in the executable state of the task to ensure the real-time service. On the contrary, as long as one side quits the task, the task terminates and exits the mutual-communication interface, and the side goes back to step 2.

Step 7, terminating task. The P2P network platform of the demander is set with a task termination option. When the demander touches the task termination option, the task terminates. Both sides can continue to publish the task.

The method further comprises the step of performing identity information authentication for the supplier and the demander before step 2. Through the authentication, the supplier and the demander are allowed to publish the task, which is beneficial for subsequent investigation and evidence obtaining and can prevent the publishing of malicious information.

The P2P network platform also tracks and records the identity information, location information and task information of the supplier and the demander in Step 2 to Step 7, and cooperates with the investigation and evidence obtaining. Wherein, the identity information includes name and contact information.

In order to facilitate communication between seniors and relatives, the categories include a relative category. The supplier or the demander is added as the relative in the sub-category of the relative category. The senior person selects the relative in the sub-category to publish the task. When the relative selects the senior person, they can communicate with each other through the mutual-communication interface, greatly enhancing the relationship between the relatives.

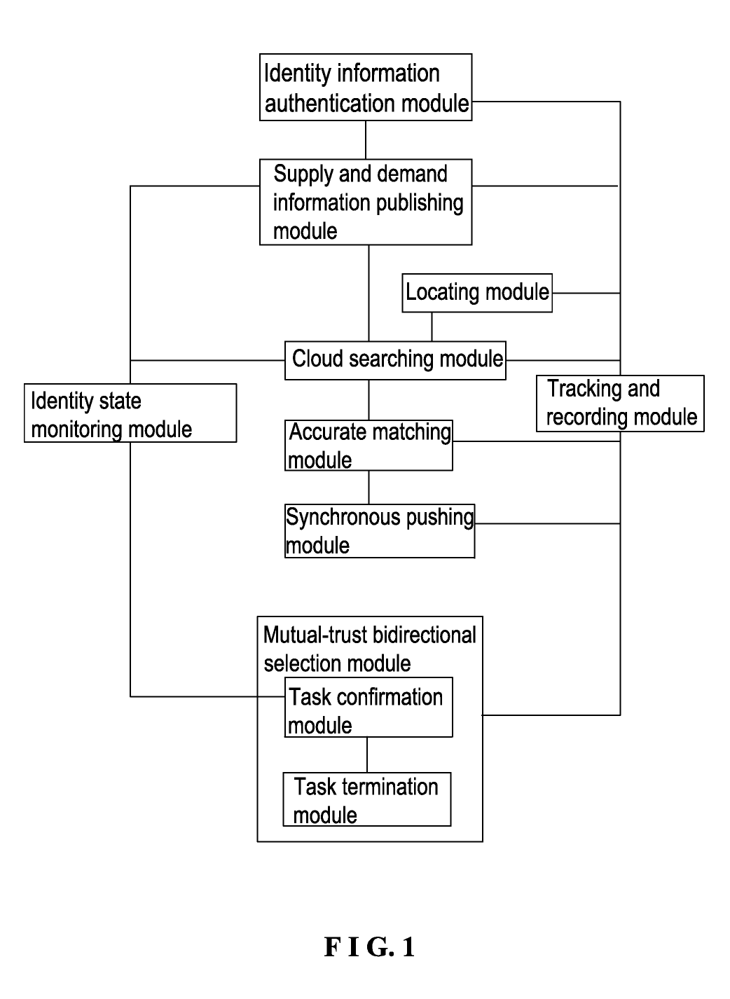

As shown in FIG. 1, this embodiment discloses a system for bidirectional instant living resource mutual assistance and emotion exchange interaction comprises a digital and quantitative P2P network platform module.

The digital and quantitative P2P network platform module is installed in a smart terminal for suppliers and demanders. The digital and quantitative P2P network platform module is preset with categories of demand and supply. The categories include a living resource mutual assistance category and an emotion exchange interaction category. The P2P network platform module is set with touch click options for the demanders and suppliers, not including self-defining options.

The P2P network platform module further includes main modules and sub-modules. The categories are pre-recorded in the main modules, respectively. The sub-categories of each category are pre-recorded in the sub-modules, respectively. The contents of the categories are described above.

A supply and demand information publishing module, a cloud searching module, a locating module, an accurate matching module, a synchronous pushing module, a mutual-trust bidirectional selection module and an identity state monitoring module are set in the P2P network platform module.

The supply and demand information publishing module is provided with a supply publishing interface and a demand publishing interface. The supply publishing interface is used for the supplier to touch and select the service category provided by the supplier and to publish the supply information on the P2P network platform module.

The demand publishing interface is used for the demander to touch and select the service category required for the demander and to publish the demand information on the P2P network platform module. The supply and demand information publishing module is also used to ensure that when in the same category, the user is allowed to select only one identity, the supplier or the demander; when in different categories, the user is allowed to simultaneously select two identities, the supplier and the demander, for performing task publishing.

The cloud searching module is connected with the supply and demand information publishing module and the locating module, respectively. The cloud searching module is used to search for the supply information corresponding to the demand information that is being published.

The locating module is used to detect the location information of the suppliers and demanders. There are many existing positioning methods, such as GPS which is widely used.

The accurate matching module is connected with the cloud searching module. The accurate matching module is used to automatically match all the supply and demand information of the cloud according to the best matching conditions, and the suppliers and demanders in the same area are selected by distance.

The synchronous pushing module is connected with the accurate matching module. The synchronous pushing module is used for a plurality of selected suppliers according to the distance close to the demander to be listed and displayed on the demand publishing interface, and for a plurality of selected demanders according to the distance close to the supplier to be listed and displayed on the supply publishing interface. Wherein, the number of the suppliers and demanders is preferably five, depending on the needs.

The mutual-trust bidirectional selection module is connected with the synchronous pushing module. The mutual-trust bidirectional selection module is used for both sides to communicate with each other according to the listed and displayed information of the synchronous pushing module. The mutual-trust bidirectional selection module is provided with a mutual-communication interface. When the supplier and the demander choose each other, the mutual-communication interface is popped. The communication of the mutual-communication interface includes audio and video, text, etc. In the mutual-communication interface, both sides can conduct further exchanges. For the living resource mutual assistance category, both sides can discuss the specific needs and the specific details of the services through the mutual-communication interface to achieve the transaction. For the emotion exchange interaction category, both sides can perform emotion exchange interaction through the mutual-communication interface.

The identity state monitoring module is connected with the supply and demand information publishing module and the cloud searching module respectively. The identity state monitoring module is used to detect the identity state of the supplier and the demander. When the identity state monitoring module detects that the identity state of the supplier and the demander is in an offline state, the supply and demand information publishing module is prohibited from publishing the task of the supplier and the demander, meanwhile, the cloud searching module stops searching.

When the supply and demand relationship selected by both sides is the living resource mutual assistance category, in order to ensure the final service task is reached and in order to ensure the quality of the service, the P2P network platform module is provided with a task confirmation module and a task termination module, and the identity state monitoring module is also provided simultaneously.

The task confirmation module is disposed on the mutual-communication interface of the mutual-trust bidirectional selection module. When both sides select the living resource mutual assistance category, the task confirmation module is displayed on the mutual-communication interface. The task confirmation module is provided with a continuing task option and a quitting task option. The task confirmation module is used to change the identity state of the supplier and the demander to an executing task state when both the supplier and the demander select the continuing task option. On the contrary, as long as one side touches the quitting task option, the task terminates immediately. The supplier and the demander can re-publish the task.

The identity state monitoring module is also connected with the task confirmation module. When the identity state monitoring module detects that the identity state of the supplier and the demander is still in the executing task state, the identity state monitoring module is used to prohibit the supply and demand information publishing module from publishing the task of the supplier and the demander, meanwhile, the cloud searching module stops the searching.

The task termination module is connected with the task confirmation module. The task termination module of the demander is provided with a task completion option. The task termination module is used for confirming the termination of the task when the demander touches the task completion option and for canceling the identity of the supplier and the demander in the executing task state.

The P2P network platform module is provided with a tracking and recording module and an identity information authentication module.

The identity information authentication module is connected with the supply and demand information publishing module. The identity information authentication module is used for identity information authentication before the supplier and the demander perform task publishing.

The tracking and recording module is connected with each of the aforesaid modules. The tracking and recording module is used for tracking and recording the identity information, the location information and the task information of the supplier and the demander. If a complaint occurs, it can be used to cooperate with the possible investigation and evidence obtaining. The identity information may include name and contact information.

In order to facilitate communication between seniors and relatives, the categories preset and recorded in the digital and quantitative P2P network platform module include a relative category. The supplier or the demander is preset as the relative in the sub-category of the relative category. The senior person selects the relative in the sub-category to publish the task. When the relative selects the senior person, they can communicate with each other through the mutual-communication interface, greatly enhancing the relationship between the relatives.

The suppliers and the demanders of the present invention establish the digital and quantitative P2P network platform which only provides the mode of touch click selection, so that the subsequent accurate matching can be realized. The suppliers and demanders can be searched by the cloud only when the suppliers and demanders are publishing information, thereby ensuring the instantaneity of implementing tasks to ensure that both sides can provide timely response and waiting is not required. Nearby suppliers and demanders are associated together through the accurate matching and a principle of proximity and are not required to be sought artificially, thereby saving a large amount of time. Both sides are enabled to have the right of acquiring information about an opposite side through the synchronous pushing, and the purposes of mutual trust, mutual assistance, mutual communication and emotion exchange interaction are achieved through the bidirectional selection.

The present invention is mainly aimed at the social relationship between people. The social relationship between people includes living resource mutual assistance and emotion exchange interaction. Other digital and quantitative social relationships can also be applied to the present invention. The system of the present invention creates a new intelligent living space for people, promotes mutual trust, mutual assistance, mutual communication between people in society, and makes it easier for people to communicate with each other instantly.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method for bidirectional instant living resource mutual assistance and emotion exchange interaction, comprising the steps of:
step 1, establishing a digital and quantitative P2P network platform, categories of demand and supply being established on the digital and quantitative P2P network platform, the categories including a living resource mutual assistance category and an emotion exchange interaction category, the P2P network platform being only set with touch click options for a demander and a supplier, not self-defining;
step 2, publishing supply and demand information, the supplier touching and selecting a service category provided on a supply publishing interface of the P2P network platform and publishing the supply information on the P2P network platform, a cloud of the P2P network platform immediately searching for the corresponding demand information being published by the demander corresponding to the supply information, wherein when the supplier exits the P2P network platform, the P2P network platform immediately stops publishing the supply information and the cloud stops searching;
the demander touching and selecting a demand category provided on a demand publishing interface of the P2P network platform and publishing the demand information on the P2P network platform, the cloud of the P2P network platform immediately searching for the supply information being published by the supplier and corresponding to the demand information, wherein when the demander exits the P2P network platform, the P2P network platform immediately stops publishing the demand information and the cloud stops searching;
step 3, performing accurate matching, the P2P network platform automatically matching all the supply information and the demand information of the cloud according to best matching conditions, a plurality of suppliers and demanders in the same area being selected by distance;
step 4, performing synchronous pushing, the plurality of selected suppliers according to the distance close to the demander being listed and displayed on the demand publishing interface, meanwhile, the plurality of selected demanders according to the distance close to the supplier being listed and displayed on the supply publishing interface;
step 5, performing mutual-trust bidirectional selection, the supplier and demander communicating with each other according to the synchronously displayed supply and demand information, wherein when the supplier and the demander choose each other, the publishing interfaces of the supplier and the demander synchronously pop a mutual-communication interface.

2. The method as claimed in claim 1, wherein when both the supplier and demander select the living resource mutual assistance category, the method further comprises the steps of:
step 6, performing task confirmation, the mutual-communication interface being set with a continuing task option and a quitting task option, wherein when both the supplier and the demander touch the continuing task option to be in an executing task state, the supplier and the demander are unable to perform task publishing, on the contrary, when the supplier or the demander touches the quitting task option, the task immediately terminates and exits the mutual-communication interface, going back to step 2;
step 7, terminating task, the P2P network platform of the demander being set with a task completion option, wherein when the demander touches the task completion option, the task terminates, and the supplier and the demander can continue to publish tasks.

3. The method as claimed in claim 1, wherein in step 1, each of the categories has sub-categories, each of the categories forms a main module, and each of the sub-categories forms a sub-module.

4. The method as claimed in claim 1, wherein in step 2, when in the same category, only one identity, the supplier or the demander, is selected to perform task publishing; when in different categories, both identities, the supplier and the demander, can be selected to perform task publishing.

5. The method as claimed in claim 1, further comprising the step of performing identity information authentication for the supplier and the demander before step 2, through the identity authentication, the supplier and the demander being allowed to perform task publishing; the P2P network platform tracking and recording identity information, location information and task information of the supplier and the demander in step 2 to step 7; the categories including a relative category, the supplier or the demander being added as a relative in a sub-category of the relative category.

6. A system for bidirectional instant living resource mutual assistance and emotion exchange interaction, comprising:
a digital and quantitative P2P network platform module, the digital and quantitative P2P network platform module being installed in a smart terminal for a supplier and a demander, the digital and quantitative P2P network platform module being preset with categories of demand and supply, the categories including a living resource mutual assistance category and an emotion exchange interaction category, the P2P network platform module being set with touch click options for the demander and supplier, not including self-defining options;
a supply and demand information publishing module, a cloud searching module, a locating module, an accurate matching module, a synchronous pushing module, a mutual-trust bidirectional selection module and an identity state monitoring module being set in the P2P network platform module;
the supply and demand information publishing module being provided with a supply publishing interface and a demand publishing interface; the supply publishing interface being used for the supplier to touch and select a service category provided by the supplier and to publish the supply information on the P2P network platform module;
the demand publishing interface being used for the demander to touch and select a service category required for the demander and to publish the demand information on the P2P network platform module;
the cloud searching module being connected with the supply and demand information publishing module and the locating module respectively, the cloud searching module being used to search for the supply information and the demand information that are being published;
the locating module being used to detect location information of the supplier and demander;
the accurate matching module being connected with the cloud searching module, the accurate matching module being used to automatically match all the supply information and the demand information of the cloud according to best matching conditions, and a plurality of suppliers and demanders in the same area being selected by distance;
the synchronous pushing module being connected with the accurate matching module, the synchronous pushing module being used for the plurality of selected suppliers according to the distance close to the demander to be listed and displayed on the demand publishing interface and for the plurality of selected demanders according to the distance close to the supplier to be listed and displayed on the supply publishing interface;
the mutual-trust bidirectional selection module being connected with the synchronous pushing module, the mutual-trust bidirectional selection module being used for the supplier and the demander to communicate with each other according to the listed and displayed information of the synchronous pushing module, the mutual-trust bidirectional selection module being provided with a mutual-communication interface, wherein when the supplier and the demander choose each other, the mutual-communication interface is popped;
the identity state monitoring module being connected with the supply and demand information publishing module and the cloud searching module respectively, the identity state monitoring module being used to detect the identity state of the supplier and the demander; wherein when the identity state monitoring module detects that the identity state of the supplier and the demander is in an offline state, the supply and demand information publishing module being prohibited from publishing the task of the supplier and the demander, meanwhile, the cloud searching module stops searching.

7. The system as claimed in claim 6, further comprises a task confirmation module and a task termination module in the P2P network platform module;
the task confirmation module being disposed on the mutual-communication interface of the mutual-trust bidirectional selection module, wherein when the supplier and the demander select the living resource mutual assistance category, the task confirmation module is displayed on the mutual-communication interface, the task confirmation module is provided with a continuing task option and a quitting task option; the task confirmation module is used to change the identity state of the supplier and the demander to an executing task state when both the supplier and the demander select the continuing task option, when the supplier or the demander touches the quitting task option, the task terminates immediately;
the task termination module being connected with the task confirmation module, the task termination module of the demander being provided with a task completion option, the task termination module being used for confirming the termination of the task when the demander touches the task completion option and for canceling the identity of the supplier and the demander in the executing task state;
the identity state monitoring module being connected with the task confirmation module, the identity state monitoring module being used to detect whether the supplier and the demander are still in the executing task state, wherein when the identity state monitoring module detects that the identity state of the supplier and the demander is in the executing task state, the identity state monitoring module is used to prohibit the supply and demand information publishing module from publishing the task of the supplier and the demander, meanwhile, the cloud searching module stops searching.

8. The system as claimed in claim 6, wherein the P2P network platform module further includes main modules and sub-modules, the categories are pre-recorded in the main modules respectively, and the sub-categories of each category are pre-recorded in the sub-modules respectively.

9. The system as claimed in claim 6, wherein the supply and demand information publishing module is used to ensure that when in the same category, only one identity, the supplier or the demander, is selected to perform task publishing; when in different categories, both identities, the supplier and the demander, can be selected to perform task publishing.

10. The system as claimed in claim 6, wherein the P2P network platform module is provided with a tracking and recording module and an identity information authentication module, the identity information authentication module is connected with the supply and demand information publishing module, the identity information authentication module is used for identity information authentication before the supplier and the demander perform task publishing; the tracking and recording module is connected with each of the aforesaid modules, the tracking and recording module is used for tracking and recording identity information, location information and task information of the supplier and the demander; the categories preset and recorded in the digital and quantitative P2P network platform module include a relative category, the supplier or the demander is preset as a relative in a sub-category of the relative category.
